(19) United States
(12) Patent Application Publication
(10) Pub. No.: US 2016/0050079 A1
(43) Pub. Date: Feb. 18, 2016

(54) TELECONFERENCE MESSAGE BOX

(71) Applicant: TELEFONAKTIEBOLAGET L M ERICSSON (PUBL), Stockholm (SE)

(72) Inventors: Arturo MARTIN DE NICOLAS, Aachen (DE); Ramsunder KANDASAMY, Aachen (DE); Tanja SCHNITZLER, Aachen (DE); Matthias SCHREIBER, Aldenhoven (DE)

(21) Appl. No.: 14/779,124

(22) PCT Filed: Mar. 27, 2013
(86) PCT No.: PCT/EP2013/056533

§ 371 Date: Sep. 22, 2015

(51) Int. Cl. H04L 12/18; H04M 3/56

(52) U.S. Cl. CPC H04L 12/1827; H04L 12/1831; H04M 3/565

(57) ABSTRACT

A teleconference system for providing a scheduled teleconference to a plurality of participants is disclosed. The system records a message before or during the scheduled teleconference, associates the recorded message with the scheduled teleconference, and provides the recorded message during the scheduled teleconference to at least one of the participants of the scheduled teleconference.

### TECHNICAL FIELD

The present invention relates to a teleconference system for providing a teleconference to a plurality of participants. The present invention also relates to a related network entity, a related computer program as well as to a related computer program product.

### BACKGROUND

Teleconference systems are commonly used for exchanging information among several participants connected through a telecommunication network. The exchanged information among the participants may include voice, text, messages, documents and/or video information. A telephone teleconference usually only involves voice, so the exchanged information is voice or sound data, whereas a video teleconference involves both voice/sound and video, so the exchanged information is voice or sound data and video data. In addition to this, the teleconference system may also allow for exchanging text messages, documents, and/or files.

In most of the cases the participants of the teleconference schedule the teleconference such that the beginning time of the conference is a priori known to the conference participants. Usually one of the participants initiates the scheduling by inviting other participants with providing date and time information on when the scheduled teleconference is to take place. Such an invitation may also include means for that the participants can later authorize themselves in order to gain access to the teleconference and/or to participate (dial in details, URLs, passwords, etc.). Of course, the above invitation needs not to be effected by a participant, since also another person or a moderator may make the invitation who is then later not participating. The conference participants then access the teleconference system at or around the scheduled time for participating.

Occasionally, some invited conference participants may choose not to attend the scheduled conference. They may also decide to participate, but only at a later time when the scheduled starting time has already passed and the teleconference is already in progress.

The conventional arts provide the possibility to join an ongoing teleconference at any time, so that a participant who chose to join later can make himself/herself heard or seen when having joined. This, however, may pose some kind of distraction to the other participants and thus generally disturbs the ongoing conference. If the one participant chose not to attend at all, the remaining participants may be kept with no information on the fact and/or reasons why one does not join. Also, the other participants may wonder when the missing participant joins and therefore delay the actual starting of the agenda. Especially, the latter result in a loss of time to all actual participants.

Conventional communication networks provide so-called mailboxes or voice mail functionalities that have been commonly used for many years. In this regard it is especially referred to network provided mail boxes, and not to terminal-connected answering machines, i.e. the voice mail functionality is provided by the network independent from the capabilities of the end user terminal (fixed line phone, IP phone, mobile/smart phone, PC, etc.).

This offers a mechanism for transferring information to a user who is not available at a certain point in time. Calls to a user are re-routed to the user's mailbox, for example when the user is busy or not reachable. The voice and/or video calls to a user may also be unconditionally routed to the user's mailbox if the user has requested that. However, in these conventional approaches the mailboxes are owned by a particular user. Although other users can leave messages, they are not allowed to access recorded messages. Only an authorized user can retrieve the messages later.

With the advent of visual communication, video mail boxes have also started to appear. For example, offline video mailboxes exist, where—if the callee is not available—then the caller can leave an “offline” video message. When the callee logs in at a later point in time, he/she will be notified about the video message for retrieval.

Thus neither existing mailboxes nor existing teleconference systems offer a suitable mechanism for a user who wants to leave a message to a scheduled conference. As a consequence, there is a need for an improved teleconference system for providing a scheduled teleconference to a plurality of participants.

### SUMMARY OF THE INVENTION

The above objects and mentioned problems are solved by the subject-matter of the independent claims. Preferred embodiments are described in the dependent claims.

An embodiment of the present invention is a teleconference system for providing a scheduled teleconference to a plurality of participants, comprising recording means for recording a message before or during the scheduled teleconference; association means for associating the recorded message with the scheduled teleconference; and providing means for providing the recorded message during the scheduled teleconference to at least one of the participants of the scheduled teleconference.

Another embodiment of the present invention is a network entity for use in a teleconference system, the entity comprising a processing unit configured to record a message during or before a scheduled teleconference, and to associate the recorded message with the scheduled teleconference.

Another embodiment of the present invention is a method for providing a scheduled teleconference including the steps of recording a message before or during the scheduled teleconference; associating the recorded message with the scheduled teleconference; and providing the recorded message during the scheduled teleconference to at least one of the participants of the scheduled teleconference.

Another embodiment of the present invention is a method for operating a network entity for use in a teleconference system including the steps of recording a message during or before a scheduled teleconference, and associating the recorded message with the scheduled teleconference.

According to further embodiments of the present invention, a computer program and a computer program product storing this program are provided. The computer program comprises code that can implement or help implementing any system, any entity, or any method of the disclosed embodiments.

According to further embodiments, the message is a voice message, a video message, a voice and video message, etc.

### BRIEF DESCRIPTION OF THE DRAWINGS

Embodiments of the present invention, which are presented for better understanding the inventive concepts but which are not to be seen as limiting the invention, will now be described with reference to the Figures in which:

FIG. 1A shows a schematic view of a teleconference system according to an embodiment of the present invention;

FIG. 1B shows a schematic view of a teleconference system according to another embodiment of the present invention;

FIGS. 2A to 2D show handshake diagrams of implementations according to embodiments of the present invention;

FIGS. 3A and 3B show flow charts of method embodiments of the present invention; and

FIG. 4 shows a schematic view of a network entity according to an embodiment of the present invention.

### DETAILED DESCRIPTION

According to embodiments of the present invention a teleconference system is providing a teleconference to a plurality of participants. The teleconference system may comprise one or more end terminals for use by the participants. The teleconference system may be a video or a voice teleconference system. Therefore, the end terminals may comprise means for inputting and outputting sound, voice and/or video. Such means may include a microphone, a loudspeaker, an audio amplifier, an earphone, an earphone plug, a camera, a screen, a light, a keyboard, a pointing device, and the like. The end terminals may also include means for processing, encoding and decoding input/output data to be handled over a network. Such a network can be a telecommunication network, such as a cellular telecommunication network, a corporate network, a local wire-bound or wireless network, the Internet and the like. The teleconference system may comprise other network entities for carrying out the teleconference.

According to embodiments of the present invention, a network entity is associated with a given functionality. In a way, the entity is thus able to provide this functionality and may thus involve respective processing, communication and memory resources. These resources may be collocated in one unit, such as a server, a computer or a processor board, but they may also well be distributed over a network or a data center. In a way, an entity may also be the collection of code and application data that is for providing the respective functionality.

The teleconference is a scheduled teleconference such that at least the beginning date and time of the teleconference is known to the participants or has been at least notified to them, for example via email. In this way, a scheduled teleconference is known to take place in advance and can be therefore managed although not yet in actual progress. It is to be noted, however, that also an ad-hoc conference in which participants decide spontaneously to hold a conference can be rendered a scheduled conference and identified as such once started. In any way, information on the scheduled conference can be maintained so as to store information on the participants, such as email addresses, names, and telephone numbers, and the date and time indicating the start of the conference, and some kind of conference identifier.

Thus also some kind of identifier can be associated with the scheduled conference which can further include agenda-related keywords etc. Further details of the scheduled teleconference may also be stored and made known to the participants. For example, the end time of the conference or the time slot assigned to each participant may also be known before the beginning of the conference. The possibility to identify a scheduled conference then also allows for making associations with a specific scheduled conference. As a result, a recorded message, i.e. text, data, voice, sound and/or video information, can be associated to the scheduled conference. For example, a file containing a video message can be associated with a given scheduled teleconference so that it can be determined that the content in the file is to be reproduced during or after the conference to all or some participants.

The scheduled conference may be provided with a conference moderator who may also be a participant. The conference moderator may, for example, invite the participants to participate to the conference by sending an invitation to each of them with the beginning date and time of the conference. The scheduled conference moderator may also be responsible for providing any other information to all the participants during the scheduled conference and also effect control of the participants joining the conference and the playback of any recorded messages during the conference.

A participant of the conference who chose not to attend the conference may want to leave a message to the other conference participants. Such a message can be played to the other conference participants for instance at the beginning, upon request by a participant or the moderator, or in the time slot assigned to the participant who chose not to attend. In a further embodiment, the recorded message may be provided to every participant at the time of joining. Yet another option is to provide the message at the time specified by the participant who left the message. In this way, the joining participant can be provided with a message informing on that and why one participant will not or only later attend the conference. Therefore, the remaining participants may proceed with the agenda and do not loose time for waiting for a not-joining participant in vain.

A recorded message is associated with the scheduled conference. In the embodiments of the present invention, associated messages are messages that are related to the particular scheduled conference and are intended to be played back (provided) during the conference. In this way, it can be ensured that the message from the non-joining participant reaches the other participants. The teleconference system can thus determine what message is to be provided when and during what conference. It is to be understood that teleconference systems handle and manage a plurality of scheduled conferences at a time, each scheduled conference having a specific number of participants.

Messages intended to be played during the scheduled conference may also be generated and recorded before or during the scheduled conference by entities of the teleconference system (Or by conference participants or by authorized conference participants). These messages are then also associated with the scheduled conference. Such messages may be played at predetermined time points or at any time that the conference moderator may choose to be appropriate. For example, such messages may announce coffee breaks or lunch breaks or announce a key speaker.

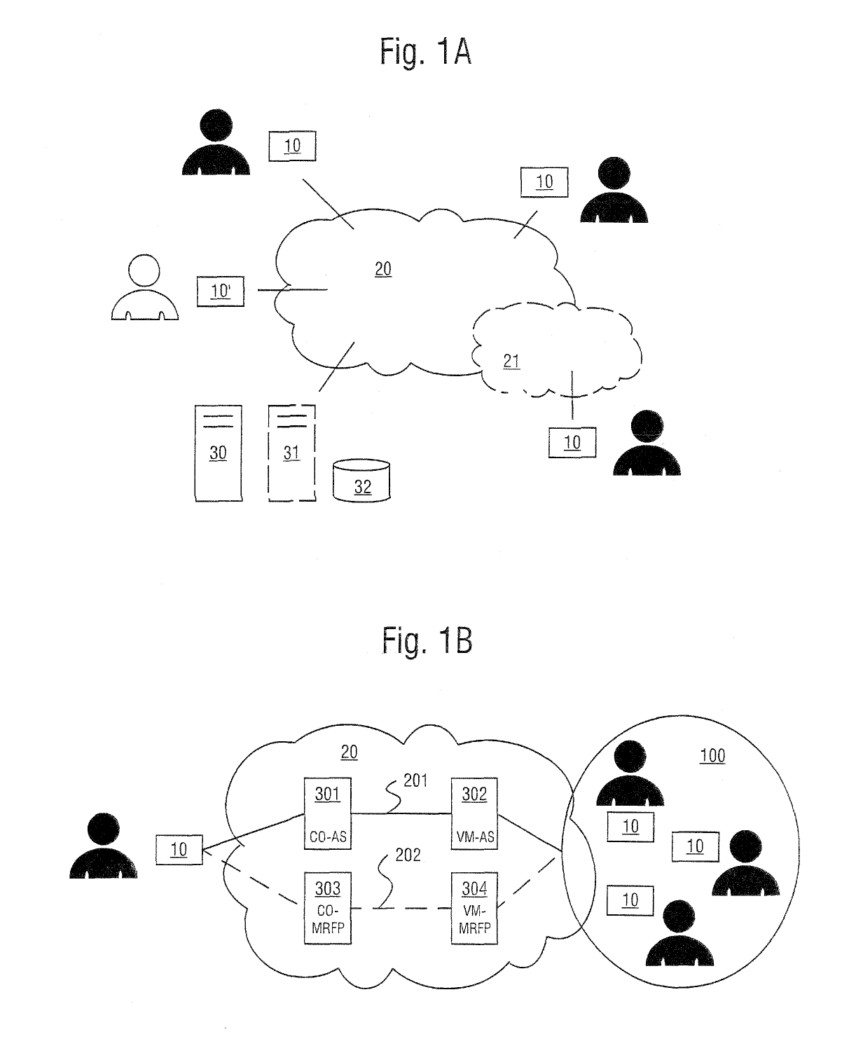

FIG. 1A shows a schematic view of a teleconference system according to an embodiment of the present invention. A plurality of participants participate in a scheduled teleconference. At least one participant chose not to attend the scheduled conference (or to at least leave a message and join (later) anyway). One or more participant(s) communicate in the teleconference through an end terminal 10. A terminal 10 comprises the means necessary for inputting and outputting voice (sound), video, text, data, etc. A terminal 10 may be in form of a personal computer (PC), notebook computer, palmtop computer, fixed line phone, personal digital assistance devices, applications or programs on a computer or a device capable of running an application, mobile telephone, smartphone, IP telephone, tablet computer, and the like.

The end terminals 10 are connected to and communicate data via a network 20. The network 20 may be any type of communication network, such as mobile communication network, wireless network, local area network (LAN), wide area network (WAN), a virtual private network or the internet. The end terminals may be connected directly to network 20 or via one ore more further network(s) 21 that is/are, in turn, coupled to the network 20. The second network 21 may be for example a cellular telecommunication network and the network 20 is the internet so that the one terminal 10 is for example a smartphone and the remaining terminals 10 are PCs with a (video) teleconference application.

A participant who chose not to attend the conference also has access to an end terminal 10′ with which he/she can provide a message to the remaining participants. The difference in this case is that the terminal 10′ forwards the contribution to the conference not directly to all further participants but forwards this contribution as a message to be recorded. It is to be noted that the contribution is given at a time when the respective scheduled conference has not yet started and the remaining terminals 10 may be off line or even shut down/disconnected. However, according to embodiments of the present invention, the participant who chose not to attend the scheduled conference is able to nevertheless give a contribution to the conference although the conference is not yet in progress. This is achieved by recording the contribution as a recorded message and by associating the recorded message with a specific scheduled conference, so that once this scheduled conference is in progress the right recorded message can be provided to the one or more target participants of the conference.

The teleconference system further comprises a network entity that is capable of communicate data with the network 20. The network entity 30 comprises processing resources configured to record messages during or before the scheduled conference. The processing resources are also configured to associate the recorded message with the scheduled conference. For storing the recorded message the entity 30 employs a data storage 32. A further entity 32 may be involved with processing resources configured to provide recorded messages during the scheduled conference. According to another embodiment though, the functionalities of the further entity 31 and/or the storage 32 are also implemented in the entity 30.

In a way, embodiments of the present invention provide a “conference-owned” (video) mail box, in contrast to a common place “user-owned” (video) mail box. For example, participants invited to a scheduled video conference are allowed to leave (video) messages in the conference mail box. Those messages can be retrieved and played (provided) during the conference so that all participants can view and/or listen to them at the same time. By means of the proposed mechanism, a message can be rendered in a timely manner to all participating users. The associating of a recorded message with a specific scheduled conference allows for proper retrieval, management, and play-back.

A preferred technology to support the deployment of this embodiment can be the IMS (IP Multimedia Subsystem) according to 3GPP, LTE, or according to a next generation telecommunication network standard/architecture. IMS offers video communication conference capabilities, either scheduled in advance or ad-hoc. In the former case of conferences that are scheduled in advance, a scheduled time and date are also known. This information may thus serve for identifying the conference and for associating recorded or generated messages. Alternatively, a new and separate identifier (typically a URL) can be generated that can identify the conference for the specific use of associating recording messages.

In the general case of ad-hoc conference, a time and date is naturally not known well in advance. However, once such an ad-hoc conference is in progress (has started), it can be well treated as a scheduled conference in the embodiments of the present invention. The only limitation may apply that a scheduled time and date are not available for identifying the conference. However, any other suitable data, such as names and/or identifiers of the participants, agenda keywords, working group names etc. may still provide sufficient uniqueness to identify such a conference. In the case of an ad-hoc conference, the use of a dedicated identifier (such as a URL) for the purpose of recording a message may be the preferred implementation. Also the actual start date and time may serve for this. In this way, users or participants who choose not to attend can leave messages that are then provided to the remaining participants during later stages of the conference or even thereafter.

FIG. 1B shows a schematic view of a teleconference system according to another embodiment, where the preferred technology of IMS is deployed. The present embodiment involves specifically the IMS entities during the realization of conference calls as follows: A Conference-AS (Application Server) 301 includes an SIP (Session Initiation Protocol) application server that realizes the conference. It also provides—amongst others—conference booking and administration functions. In MMTel (IMS Multi media telephony), a conference AS is often implemented in combination with an MMTel AS (MTAS) (MMTel Application Server).

An MRFC (Multimedia resource function controller) 303 controls the resources in an MRFP (multimedia resource function processor) 304. This node can be often found integrated with the conference AS 301. The MRFP 303 node handles the media and performs conference related operations such as audio mixing, video mixing or video switching, transcoding, announcement recording and playing, etc. Other nodes, like P-CSCF, S-CSCF, I-CSCF, (Proxy, Interrogating, Serving Call Session Control Function) MGCF (media gateway controller function), SEG (Session Border Gateway), HSS (Home Subscriber Server), etc. can also be involved in the handling of the media and signaling. In this way, content data and control signaling 201 and 202 are exchanged so as to provide the conference amongst terminals 10, possibly also a group 100 of terminals 10, over network 20.

The procedure in a system as depicted in FIG. 1B may be as follows: Either a conference unified resource location (URL) or a new URL can be made available for those participants who have been invited to a scheduled conference. In both these cases the URL(s) is/are created when the conference is scheduled. The participants are now allowed to call this URL and leave a video, multi-media, voice, or text message. In an embodiment, this URL would be available to access the conference mailbox until a predefined threshold before the start time of the conference.

A new network component Video Mailbox AS (VM-AS) 302 will be involved so that calls to the aforementioned URL will be directed to the Video Mailbox AS 302. The VM-AS 302 will control a new network component VM-MRFP 304 that will prompt the caller, for example with a recorded video message, and will instruct it to record a message from the caller. Under the instructions of the VM-AS 302, messages can be recorded, stored and re-played (provided) in the VM-MRFP 304. At the start of the conference, the conference AS 301 will contact the VM-AS 302 to check for recorded messages.

This checking for (determining of) recorded messages can be triggered by, for example, automatically considering a timestamp associated with the start of the conference, supplementary service codes such as pressing of key (either DTMF tones or SIP EVENTS), a web interface with HTTP signaling, or a client interface with enhanced features, like augmented reality with additional buttons, gesture control or speech recognition. Especially the latter three options can be implemented in or controlled by the terminals 10 by means of respective user operations.

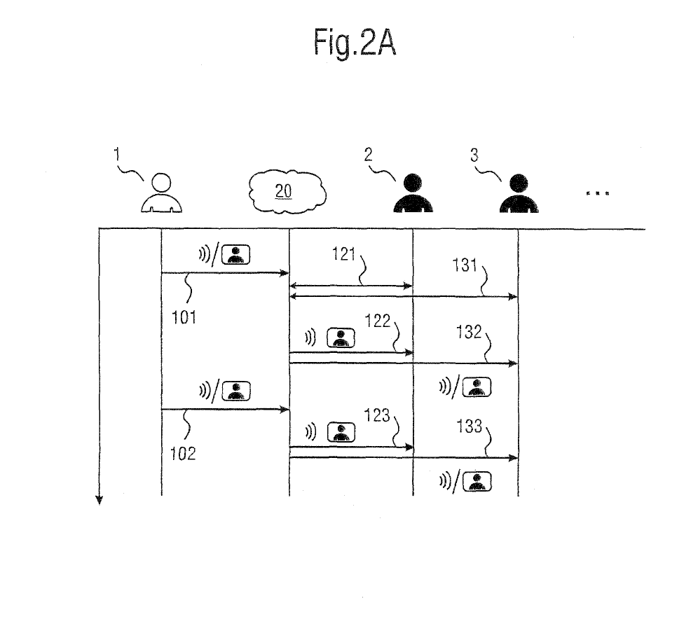

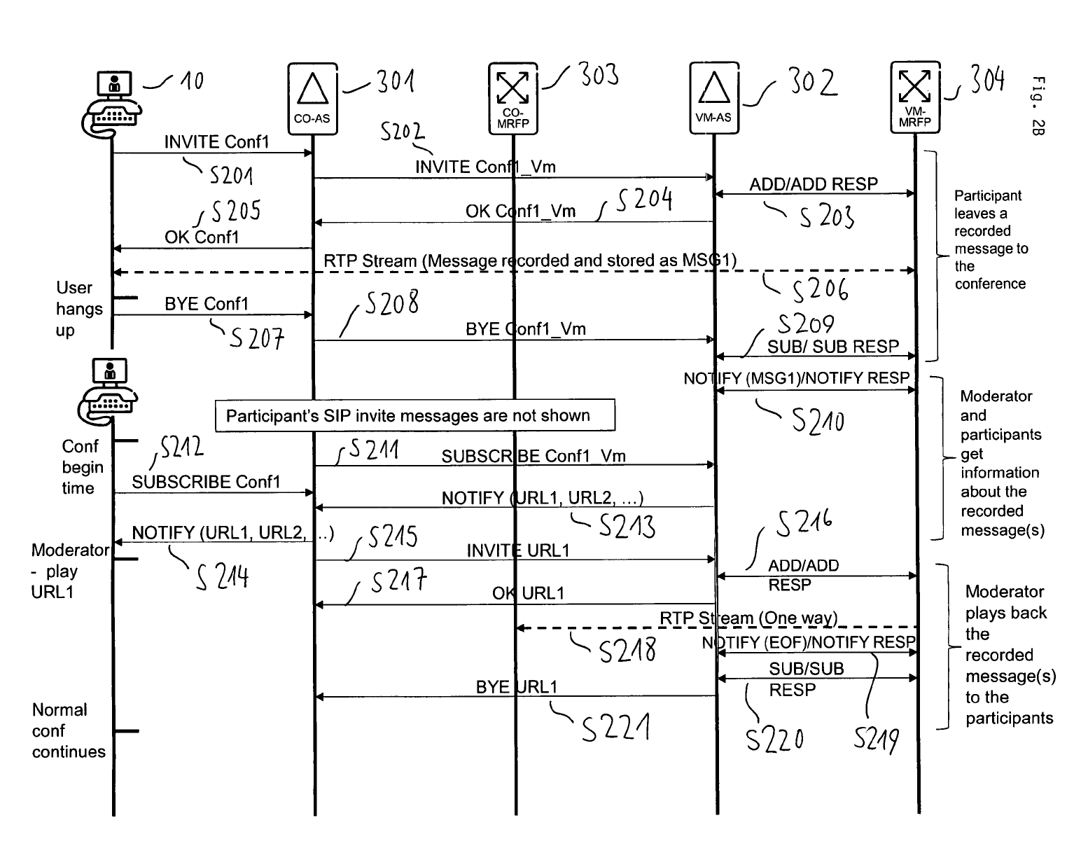

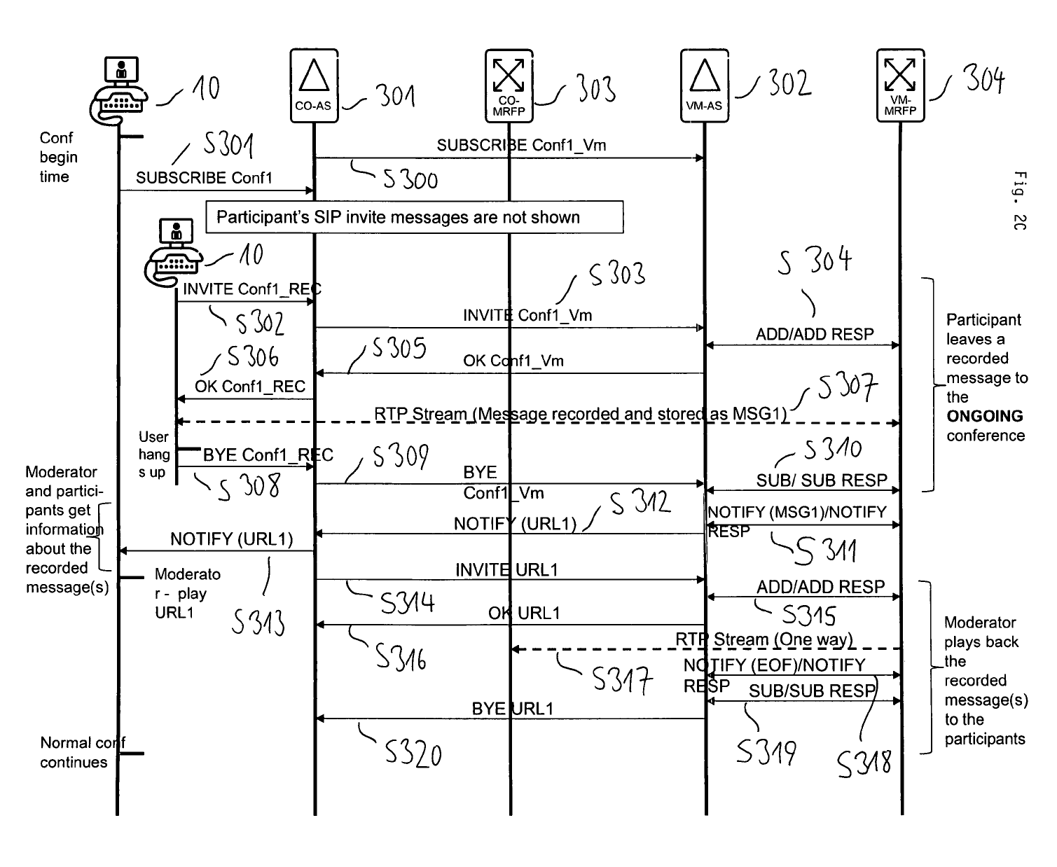

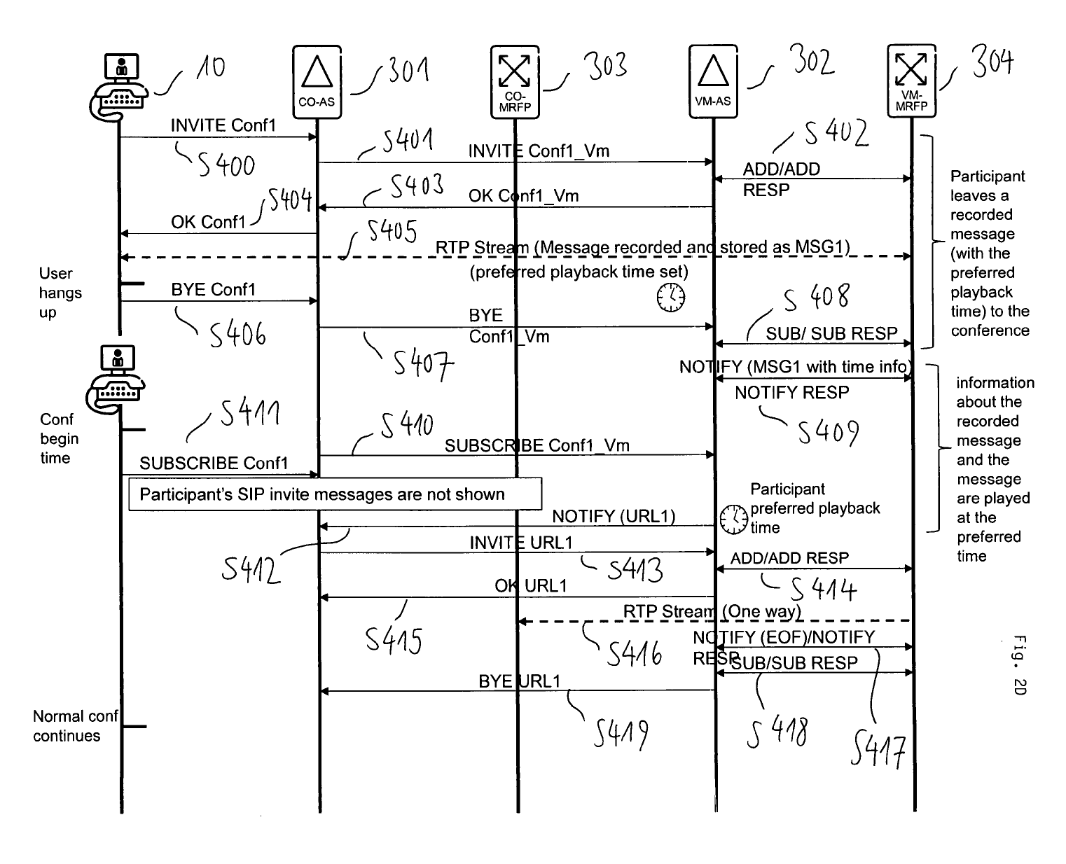

In the following, additional reference is made to the handshake diagrams of FIGS. 2B to 2D is made. Particularly, once the above trigger has occurred, the checking for messages can be realized by a SIP Subscribe message sent by the conference AS to the VM-AS, and if messages are available, then the VM-AS will inform the conference AS, for example, by means of a SIP Notify message. The conference AS will inform at a minimum the conference moderator (others can also be informed). This is dependent on whether the conference has been scheduled with or without moderator policy.

The conference moderator, or alternatively other participants, can request the Conference-AS to play a selected recorded video message, or all recorded video messages in sequence. The playing of the message/s could be triggered via—for example—supplementary service codes controlled by pressing a key (either DTMF tones or SIP EVENTS), a web interface with HTTP signaling, a client interface with additional features, like augmented reality, e.g. additional buttons, gesture control or speech recognition. Again, functionalities of the terminals 10 controlled by respective user operations may be involved.

In general, all the operation and control functionality could be provided with a web/client interface for each conference through which the conference participants could view (streaming) or download the messages. Also this may give the possibility for the participants to view the messages in their preferred and personally most convenient way (device/connectivity). The web/client interface may be controlled by respective user operations.

The Conference-AS will then establish a session towards the VM-AS. In this session the VM-MRFP will be connected to the conference MRFP. The VM-AS will instruct the VM-MRFP to play the requested video message. The Conference MRFP will forward the video and audio to the rest of the participants, using common conference media processing techniques (video mixing or switching, audio mixing, transcoding, etc.). Optionally, an MRCP (media resource control protocol) control channel can also be established towards the VM-AS for the control of the playback of messages, allowing for example for fast-forward and rewind operations.

Additionally, (video) messages could be recorded with a timestamp as a trigger, so that they are played at a specific time during the conference, for example, a conference is scheduled from 9:00 am to 5:00 pm, and recorded messages are played at 10 am, 1 pm and 3 pm to, for example, announce that coffee and lunch are being served. Also the timestamp may point to a time slot given to a specific participant. If this participant chose not to attend in person, then his or her message (contribution) can be automatically provided to the other participants at the right time. The above timestamp may in more general terms be identified with a scheduled time for determining when the message is to be played/provided.

This would involve the VM-AS not requiring a trigger from the moderator or participants during the conference, but it would dial into the conference (SIP INVITE) and play the recorded message when the prerecorded time was reached. A preferred implementation (cf. also FIG. 2D) considers at a predefined time that the VM-AS sends a SIP Notify to the CO-AS. The CO-AS may then be still required to send a SIP-INVITE to the VM-AS. The VM-AS may thus support the recording of a “prompt video message” (normally by the conference creator or moderator) that is used as a greeting for recording, and the VM-AS may also support requests to delete a recorded message. In that case it will instruct the VM-MRFP to do so. The messages can be viewed after the conference has ended, for either a default period of time set in the VM-AS, e.g. 7 days, or for a period of time defined by the person who has recorded the message or for a period of time defined by the moderator. The messages can also be deleted by an administrator/super user, the conference moderator or by the person who recorded the initial message.

According to a further embodiment, a moderator is provided with an enriched user interface through which he/she could control the playback of a message when it is being played during the conference. E.g. the moderator could fast forward or rewind or to pause the video during the playback so that those actions are carried out in a centralized manner. As previously mentioned, the use of MRCP can be an option to convey this type of control commands. The control as such can be again provided by the terminal 10.

As an option, the described VM-AS functionality can also be integrated in the existing conference-AS and/or the described VM-MRFP functionality can also be integrated in the existing MRFP.

As already mentioned, there is also the possibility to record messages during the conference for participants who do not wish to take part. For example, a recorded message set to be played at a certain time to remind all that the key speaker will attend shortly, or to take a coffee break. This could be facilitated by an additional (second) URL specifically for this purpose.

FIG. 2A shows a procedural diagram of a general implementation according to another embodiment of the present invention. In general terms, a user (participant) 1 leaves a (video) message 101 to an entity in the network 20. Users (participants) 2 and 3 have a teleconference over the network 20. This involves the communication 121 and 131. At some point in time it is decided that the recorded message from user 1 is to be provided to users 2 and 3. In this way, the message from user 1 can be provided in 122 and 132 to the remaining participating users 2 and 3 of the conference. Further embodiments of the present invention also envisage that user 1 can leave a message 102 during an ongoing conference. In this way, user 1 is not a “full” participant, but he/she is still able to contribute to the conference. This may be desired if, for example, user 1 wants to contribute but has only time to do so when other participants are already talking. Nevertheless, the message 102 can be provided to users 2 and 3 at an appropriate time in 123 and 133.

Again with reference to FIGS. 2B to 2D it is referred to possible and exemplary handshaking and signaling amongst the involved entities, i.e. the terminal(s) 10, the CO-AS 301, the CO-MRFP 303, the VM-AS 302, and the VM-MRFP 304. Specifically, FIG. 2B depicts the situation in which a message is recorded before the starting of a scheduled conference, FIG. 2C depicts the situation in which a message is recorded during a conference and the participants are notified of the additional contribution in the message, and FIG. 2D depicts the situation in which a message is recorded with a preferred playback time (e.g. a timestamp).

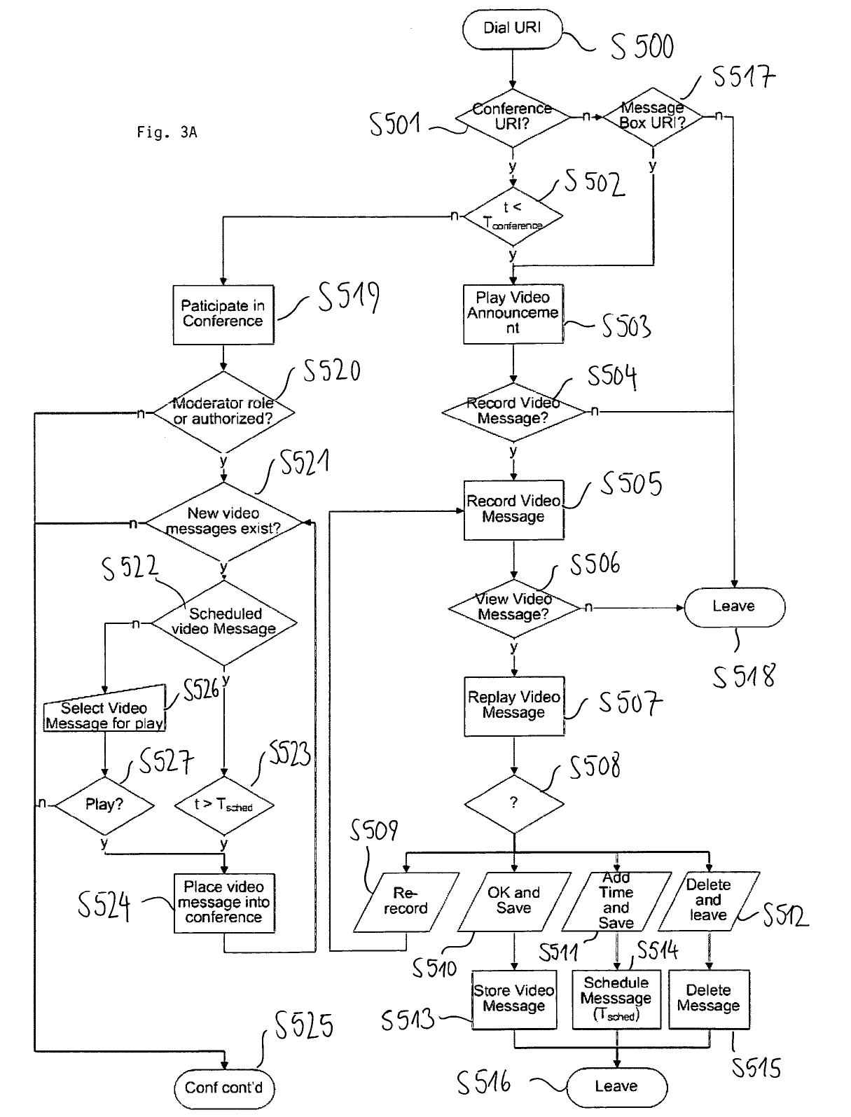

FIGS. 3A and 3B show flow charts of method embodiments of the present invention. Whereas FIG. 3A shows a more detailed embodiment, FIG. 3B depicts are more general method embodiment of the present invention. Specifically, the latter involves a step S10 of recording a message, a step S20 of associating a message with a scheduled conference, and a step S30 of providing the recorded message or a generated message during the scheduled conference.

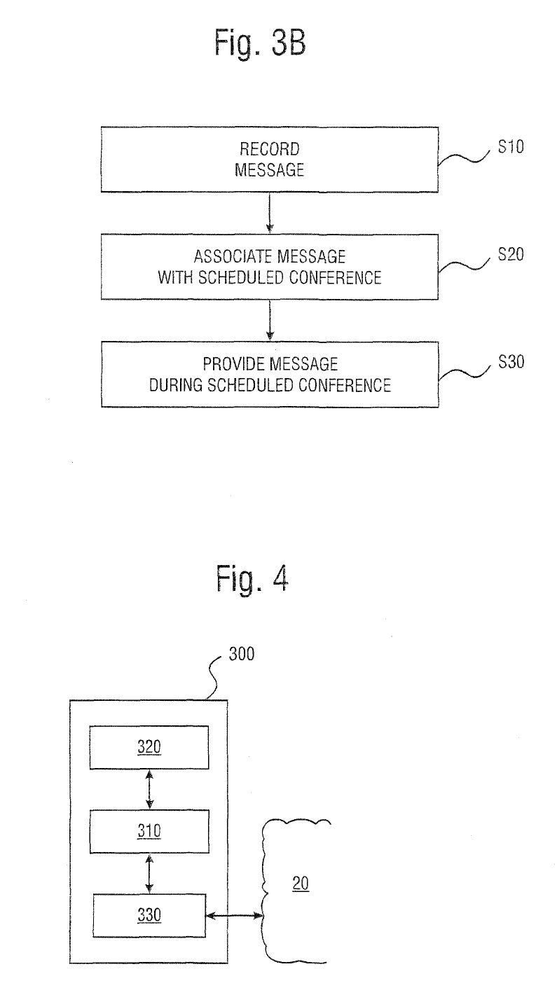

FIG. 4 shows a schematic view of a network entity according to an embodiment of the present invention. The entity 300 is able to provide one or more functionalities of embodiments of the present invention and thus comprises processing resources 310, such as a processing unit, memory resources 320, such as a memory and/or a data storage, and communication resources 330, such as a communication unit/interface, so as to be able to communicate and exchange information with network 20. The resources 310, 320, 330 may be collocated in one unit, such as a server, a computer or a processor board, but they may also well be distributed over a network or a data center.

For the entity 300 providing the one or more functionalities of embodiments of the present invention, the processing resources 310 execute code, instructions, applications, or programs that are stored in the memory resources 320. The involved data may also be retrieved from other locations over network 20 via the communication resources 330.

The embodiments of the present invention are specifically able to provide one or more of the below advantages. Embodiments of the present invention can enhance the (video) conference service, as it provides a reliable means for those users invited to a scheduled conference who however cannot participate, to provide video message that can be rendered to all participating users simultaneously during the conference.

Since existing video/voice mail boxes do not offer a suitable mechanism for a user who wants to leave a video message dedicated to a scheduled conference which he or she cannot attend, embodiments of the present invention can still provide a possibility for such users to attend “off line”. For example, instead of leaving an offline video message only to the conference moderator (who could eventually discard the message), all the participants can be notified of and provided with the message and the corresponding contribution from the user.

Although detailed embodiments have been described, these only serve to provide a better understanding of the invention defined by the independent claims, and are not to be seen as limiting.

1. A teleconference system for providing a scheduled teleconference to a plurality of participants, comprising:
at least one processor performing operations comprising:
recording a message before or during the scheduled teleconference;
associating the recorded message with the scheduled teleconference; and
providing the recorded message during the scheduled teleconference to at least one of the participants of the scheduled teleconference.

2. (canceled)

3. The teleconference system according to claim 1, wherein the operations to record the message provide a first uniform resource locator reachable to leave the message.

4.-8. (canceled)

9. The teleconference system according to claim 1, wherein the operation further comprise receiving a user operation, and determining whether there is available a message in response to the user operation.

10.-14. (canceled)

15. The teleconference system according to claim 1, wherein the operation further comprise recording a scheduled time indicating when the message is provided during the scheduled teleconference.

16. The teleconference system according to claim 1, wherein the operation further comprise identifying the scheduled conference with an identifier used when associating a recorded message to the scheduled conference.

17.-18. (canceled)

19. A network entity for use in a teleconference system, the entity comprising processing resources configured to:
record a message during or before a scheduled teleconference, and
associate the recorded message with the scheduled teleconference.

20.-23. (canceled)

24. The network entity according to claim 19, wherein the processing resources are configured to provide a first uniform resource locator reachable to leave the message.

25. The network entity according claim 24, wherein the first uniform resource locator is available until a predetermined threshold time before the start of the scheduled teleconference.

26.-28. (canceled)

29. The network entity according to claim 19, wherein the processing resources are configured to determine whether there is available a message at a predetermined time.

30. The network entity according to claim 19, wherein the processing resources are configured to receive a user operation and to determine whether there is available a message in response to the user operation.

31. The network entity according to claim 19, wherein the processing resources are configured to provide a selected message and/or a plurality of messages in a sequence.

32. (canceled)

33. The network entity according to claim 19, wherein the processing resources are configured to provide the recorded message during a predetermined time period after the end of the scheduled teleconference.

34. The network entity according to claim 19, wherein the processing resources are configured to provide a second uniform resource locator for retrieving the message during the scheduled teleconference.

35. (canceled)

36. The network entity according to claim 19, wherein the processing resources are configured to record a scheduled time indicating when the message is provided during the scheduled teleconference.

37. The network entity according to claim 19, wherein the processing resources are configured to identify the scheduled conference with an identifier used when associating a recorded message to the scheduled conference.

38.-39. (canceled)

40. A method for providing a scheduled teleconference, the method comprising:
recording a message before or during the scheduled teleconference;
associating the recorded message with the scheduled teleconference; and
providing the recorded message during the scheduled teleconference to at least one of the participants of the scheduled teleconference.

41. The method according to claim 40, further comprising recording a scheduled time indicating when the message is provided during the scheduled teleconference.

42. A method for operating a network entity for use in a teleconference system, the method comprising:
recording a message during or before a scheduled teleconference, and
associating the recorded message with the scheduled teleconference.

43. The method according to claim 42, further comprising recording a scheduled time indicating when the message is provided during the scheduled teleconference.

44. A computer program product comprising a non-transitory computer readable storage medium storing program code executable by a processor of the network entity to cause the network entity to operate according to claim 19.

45. (canceled)
